(19) United States
(12) Patent Application Publication
(10) Pub. No.: US 2011/0035387 A1
(43) Pub. Date: Feb. 10, 2011

(54) SYSTEM AND METHOD FOR THE CONTROLLED INTRODUCTION OF NOISE TO INFORMATION FILTERING

(75) Inventors: Shoshana K. Loeb, Philadelphia, PA (US); Thimios Panagos, Madison, NJ (US)

Correspondence Address: TELCORDIA TECHNOLOGIES, INC., ONE TELCORDIA DRIVE 5G116, PISCATAWAY, NJ, 08854-4157, US

(73) Assignee: TELCORDIA TECHNOLOGIES, INC., Piscataway, NJ (US)

(21) Appl. No.: 12/639,306

(22) Filed: Dec. 16, 2009

Related U.S. Application Data
(60) Provisional application No. 61/232,638, filed on Aug. 10, 2009.

(51) Int. Cl. G06F 17/30

(52) U.S. Cl. 707/754; 707/E17.059

(57) ABSTRACT

A system and method for controlled introduction of noise to information filtering, comprises requesting, directly or indirectly, infatuation by a user having a user profile, obtaining the requested information, generating the noise related to the requested information and the user profile, and presenting the requested information and the noise in an information stream. Generating can further comprise finding aggregate profiles relevant to the user profile, obtaining the noise from non-overlapping parts of the aggregate profiles, and prioritizing the noise based on predefined rules. In one embodiment, each of the aggregate profiles comprises at least one characteristic found in the user profile. The aggregate profiles can be constructed using data mining or data aggregation mechanisms. In one embodiment, the noise is generated using random selection or complex selection algorithms.

### CROSS REFERENCE TO RELATED APPLICATIONS

The present invention claims the benefit of U.S. provisional patent application 61/232,638 filed Aug. 10, 2009, the entire contents and disclosure of which are incorporated herein by reference as if fully set forth herein.

### FIELD OF THE INVENTION

The present invention relates generally to information filtering, personalization, and user modeling.

### BACKGROUND OF THE INVENTION

In the Aug. 2, 2009 issue of the New Your Times article entitled “Serendipity, Lost in the Digital Deluge” Damon Darlin exclaims that “We've gained so much in the digital age. We get more entertainment choices, and finding what we're looking for is certainly fast. Best of all, much of it is free. But we've lost something as well: the fortunate discovery of something we never knew we wanted to find. In other words, the digital age is stamping out serendipity.”

Information filtering systems such as movies, music and books recommendation systems or personalized news services enable the selective dissemination of information to users based on their given needs and wants. These systems are centered on the accurate modeling of both the user needs and wants and the characteristics of the available information. These models take the form of a user's profile that models the user's preferences and information needs over time and of metadata and data reduction representations to capture the characteristics of the available information. The information filtering systems then compare and match user's needs and wants to the available information. The problem that arises with these systems is that they rob the user of opportunities for the serendipity or the discovery through stumbling across items that the user did not know to ask for. This serendipitous discovery process is equivalent to browsing your friend's book shelf for books you never knew existed.

Prior work in information filtering was limited as described above and did not address the problem of serendipitous discovery directly. For example, previous work by S. Loeb at Telcordia on the personalized music system LyricTime, (reported in S. Loeb “Architecting Personalized Delivery of Multimedia Information” Communications of the ACM, December 1992, vol. 35, pp. 39-48) introduced the concept of “noise” by adding, to the user's list of songs, some randomly picked items every once in a while. Also, the premise of “collaborative filtering” in its original form as conceived by Telcordia researchers in the 1990s has been presented, see Recommending And Evaluating Choices In A Virtual Community Of Use, Will Hill, Larry Stead, Mark Rosenstein and George Furnas, Bellcore; CHI 1995. Similar techniques are now used extensively by Amazon, Netflix® and many others. The basic mechanism of collaborative filtering could be perceived as a mechanism to introduce noise into the user profile; however, it was not intended to be used for this purpose. The invention described here takes a general approach to the issue of serendipitous discovery or controlled noise introduction and presents a generalized system and method for the generation of noisy context sensitive information for the purposes of broadening user's interests and enabling the discovery of new items of interest in a time and context sensitive fashion.

### SUMMARY OF THE INVENTION

The inventive system and method introduces serendipity, sometimes denoted as “noise”, into the items presented to the user during an information filtering process performed by an information filtering system. The invention comprises a method and a system for serendipitous discovery or the controlled introduction of noise into the information filtering process as a way to enable the exploration of new information items of interest by the user.

The inventive solution defines in a general way prioritized sources of serendipitous discovery for an information filtering process. As an example, these sources can include a collection of profiles that represent the “averaged” preferences of segments of the entire users' population that have any overlap with the user's profile. These profiles are created by grouping individual profiles of segments of the population, for example, users with the same demographics, or with the same general interests, or from the same country of origin etc. In this example, the noise is selected from the non-overlapping part of the profiles and is then prioritized for delivery to the user.

The inventive system, in one aspect, may include an information filter obtaining information in response to a direct request by a user having a user profile or an indirect request based on the information filtering for the user, a noise generator generating the noise related to the obtained information and the user profile, and an information presenter presenting the obtained information and the noise in an information stream. The system may also include information profiles, wherein the noise generator finds aggregate profiles relevant to the user profile, said noise generator obtains the noise from non-overlapping parts of the aggregate profiles and prioritizes the noise based on predefined rules. In one embodiment, each of the aggregate profiles comprises at least one characteristic found in the user profile. In one embodiment, the aggregate profiles are constructed using one of data mining, and data aggregation mechanisms. The noise generator may generate the noise using random selection and/or complex selection algorithms. The information presenter may present using printing, transmitting electronically, and/or displaying.

The inventive method may include requesting information either directly by a user having a user profile or indirectly based on the information filtering for the user, obtaining the requested information, generating the noise related to the requested information and the user profile, and presenting the requested information and the noise in an information stream. Generating can further comprise finding aggregate profiles relevant to the user profile, obtaining the noise from non-overlapping parts of the aggregate profiles, and prioritizing the noise based on predefined rules. In one embodiment, each of the aggregate profiles comprises at least one characteristic found in the user profile. The aggregate profiles can be constructed using data mining or data aggregation mechanisms. In one embodiment, the noise is generated using random selection or complex selection algorithms.

A program storage device readable by a machine, tangibly embodying a program of instructions executable by the machine to perform methods described herein may be also provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates Profile as a List of Bought Items;

FIG. 2 illustrates Profile as a List of Interests;

FIG. 3 illustrates the generalized scheme of the present invention;

FIG. 4 shows components of an information filtering system;

FIG. 5 is a high level flow inside the Noise Generator; and

FIG. 6 shows a flow diagram of the inventive method.

### DETAILED DESCRIPTION

The invention comprises a method and a system for serendipitous discovery or the controlled introduction of noise into the information filtering process as a way to enable the exploration of additional, unfiltered information items of interest by the user.

Information filtering systems are used to deliver personalized information to users. The information filtering system typically resides somewhere between the information sources and the user and contains or can obtain profiles of all the users it serves. Every given user may have one or more (sub) profiles which are time and context sensitive.

The inventive system enables the controlled generation of serendipitous discovery or noise during the process of time and context sensitive information filtering. The serendipitously discovered items are offered to the user in addition to items that are personalized based on his profile. Also, as used herein, “user profile” means the active profile for the user in the current context, not necessarily a static and/or pre-recorded profile. The context is determined by time, location, task the user is engaged in, e.g., context, and other parameters. The part of the filter that generates the serendipitous discovery is denoted as “The Noise Generator”.

The inventive system and method is based on the approach that the serendipitous discovery is created not from the complete universe of items to be filtered but from particular subsets of that universe or space. Selecting from particular subsets is done in order to increase the probability that the so-generated serendipitous discovery would be of interest to the user at the point in time and in the specific context in which the search was undertaken.

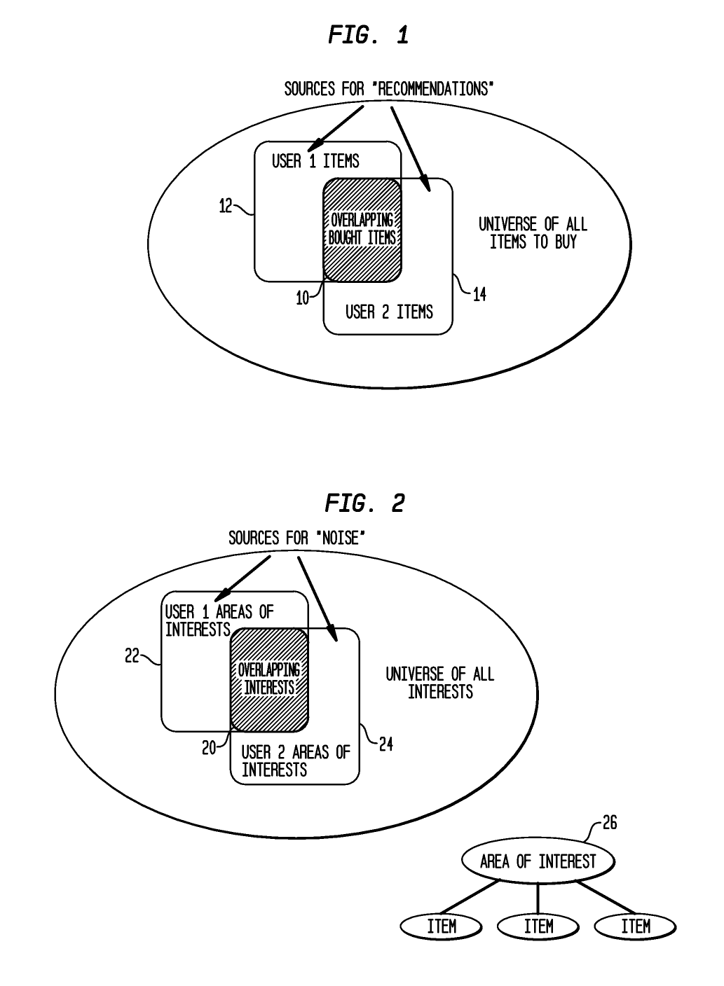

FIG. 1 depicts a simple use case for this approach which comprises the method of collaborative filtering. As shown in this figure, user 1 and user 2 have an overlapping part 10 of the information items they previously enjoyed. In this case, the non-overlapping part of the profile, e.g., the non-intersection portion of either user 1's profile 12 or user 2's profile 14, serves as source for serendipitous discovery. Items can be picked randomly from this non-overlapping area of user 1 12 and offered to user 2. Items can also be picked using more complex selection algorithms.

This collaborative filtering-based recommendation method can be generalized and, instead of looking at overlapping items that the two users chose in the past, general profile overlap can occur. For example, the two users both have an overlapping area, e.g., both say they like classical music, but user 1 also says he likes music from the fifties (non-overlapping area) and user 2 does not mention this category, so that items from the non-overlapping area, e.g., category of music from the fifties, can be offered to user 2 as serendipitous discovery.

FIG. 2 illustrates a situation in which a user's area of interest replaces the user profile items 12, 14 shown FIG. 1. In FIG. 2, there is an intersecting or overlapping area of interest 20 between users 1 and 2. Also, user 1 has an area of interest 22 that does not overlap with user 2's known or profiled interests, and similarly, user 2 has an area of interest 24 distinct from user 1's interests. For example, user 1 likes to look at new car information, in which case this category of items can be offered to user 2 as serendipitous discovery. In this case, a classification hierarchy or ontology 26, shown in the right bottom of the figure, is used for the selection process and items from the hierarchy can be selected randomly or by using specific rules or selection algorithms.

The invention generalizes the process of serendipitous discovery further by replacing the profile or interests of user 1 with a collection of aggregate or averaged profiles of various groups of users. These profiles can be constructed using known data mining or data aggregation mechanisms. In one embodiment, each profile in the aggregate profiles includes at least one characteristic found in the profile or interests of user 1.

Examples of possible groups include: users with overlapping interests in some level of abstraction, users from the same demographics (age, address, education), users with the same education and level of income, etc., users that perform the same task now or in the past, users with similar context (e.g., on vacation).

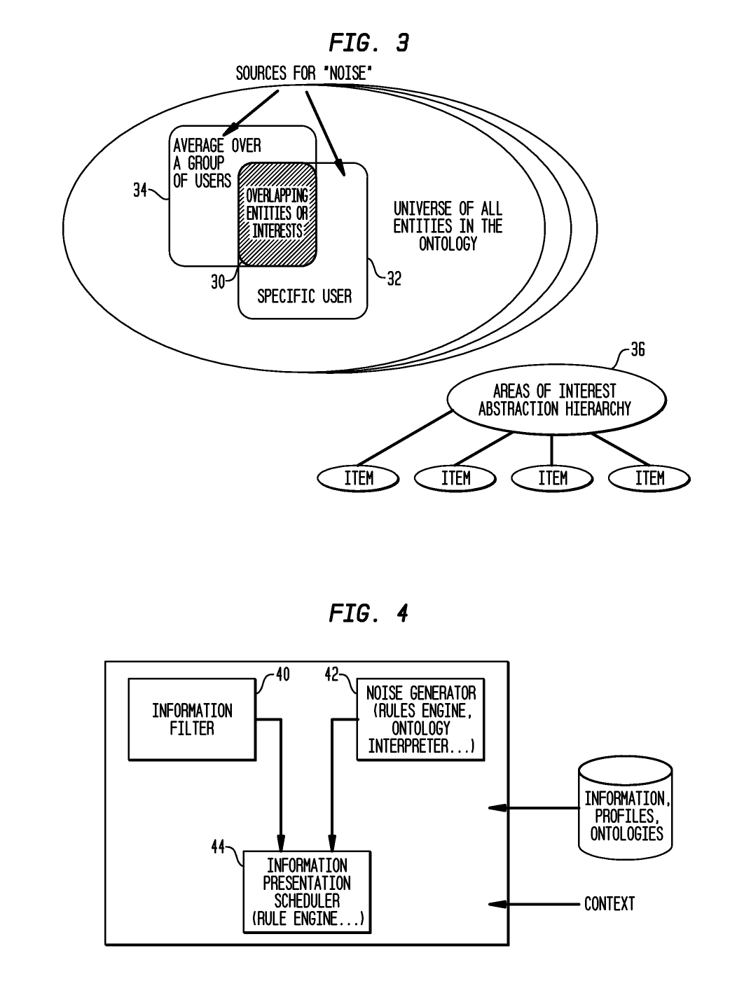

There are many ways that this average profile can be constructed and each option provides a new source of serendipitous discovery for the filtering mechanism. FIG. 3 shows an exemplary construction including overlapping entities 30, a specific user 32 and the average profile 34. Like the example in FIG. 2, in FIG. 3 a classification hierarchy 36, shown in the right bottom of the figure, can be used for the selection process. Since the inventive approach is time and context sensitive, the grouping of the users can be time and context sensitive too. Some examples follow.

In one example, a particular type of music (music-class-A) is popular amongst an average profile of research and design engineers with advanced degrees and being of Asian descent, during the Christmas Holiday season. The user undertaking information filtering is a research and design engineer but not of Asian descent and the items of this class, e.g., music-class-A, are not part of his profile. In this case, items from this class of music can be added as serendipitous discovery if the user is looking for music during this time.

In another example, a user undertaking information filtering is on vacation in Northern California and lives in the Mid-Atlantic region of the United States and is of Greek origin. The sum of the aggregate profiles for that point in time, from which serendipitous discovery can be obtained, can include people living on the West Coast and visiting Northern California that have roots in Greece and are of similar circumstances and backgrounds. The serendipitous discovery information is added to the personalized information stream that is based on the user profile.

In another example, a user undertaking information filtering is on vacation in Northern California and lives in the Mid-Atlantic region of the US and is of Greek origin. The sum of the aggregate profiles for that point in time, from which serendipitous discovery can be obtained, can include people from the Mid-Atlantic region of the US that visited Northern California in the past.

The serendipitous discovery information to be presented to the user is selected by looking at the most popular and/or most significant items in the average profile and prioritizing them based on “weights” which signify the relative importance of the items. There are several known algorithms to compute weights that can be used.

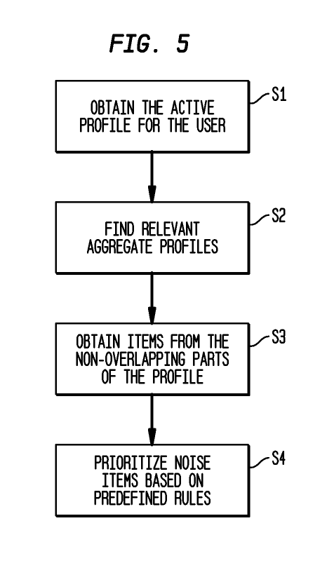

The overall system architecture is shown in FIG. 4. In this figure, three entities are shown. The main information filter 40 is based on the user's individual profile that is active at the time. This information filter 40 obtains relevant information items in accordance with a filtering request, such as a request from a user for information. The Noise Generator 42 operates to obtain serendipitous discovery items. The information presentation delivery module 44 schedules the delivery of the items provided by the filter 40 and the Noise Generator 42. This module 44 can use a variety of techniques, such as a rules engine, algorithmic methods, etc., to schedule delivery. The items can be delivered and/or presented by the module 44 in multiple ways, including printing, displaying on a computer monitor, a hand-held device, a wireless device, transmitting as an electronic message such as SMS or text, etc.

The overall high level flow in the Noise Generator 42 is shown in FIG. 5. In Step S1, the active profile for the user is obtained. In step S2, the relevant aggregate profiles are collected; relevance can be based on time and/or context. In step S3, the serendipitous items are obtained from the non-overlapping parts of the profiles found in steps S1 and S2. These items can be obtained randomly and/or using selection algorithms, as discussed above. In step S4, the items obtained in step S3 are prioritized based on predefined rules and/or algorithms.

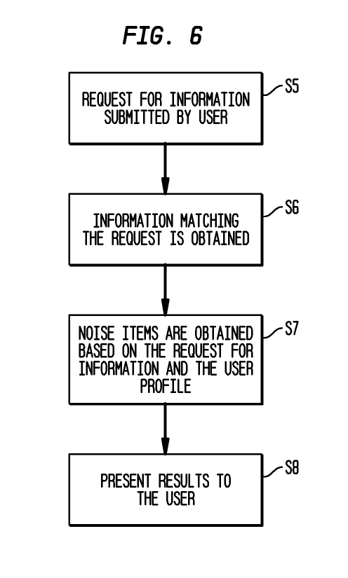

FIG. 6 is a flow diagram of the overall information filtering system including the Noise Generator 42. A user or requestor submits a query or request for information, either directly or indirectly, in step S5. In some situations, the user directly submits the query or request. At other times, the information filter 40 generates and submits the query on behalf of the user; in this situation, the user does not take any action and the query is submitted or requested automatically. The information filter 40, in step S6, obtains information items matching or corresponding to the request. In step S7, the Noise Generator 42 obtains serendipitous items, in accordance with the general process shown in FIG. 5. The results or information stream are provided to the user in step S8, and can be presented in a variety of ways, including on a computer monitor, via a portable device, as a computer printout, as a text message, etc.

The frequency by which the serendipitous discovery is added to the personalized information stream can be computed in real-time based on all available information or can be a static parameter based on a percentage of discovery or noise that is optimal for the user.

Advantageously, the serendipitous discovery broadens the user's horizon, as discussed above. The discovery information items retrieved by the Noise Generator 42 appear in addition to the information stream that the user receives. The serendipitous discovery information items are not the only source of information and it is likely that one or more items, or even all of them, will be rejected by the user.

The user profiles that are not active at the particular time that information filtering is taking place can also be used as a source of serendipitous discovery. For example, if the user indicated that he likes quiet music while at home and lively music while driving, the noise generator may insert quiet music while the user is driving as occasional noise.

The ultimate aggregate group profile is for the group of all users known to the system. A profile of the preferences of the population as a whole is what provides the lists of best sellers or other items of most interests. This mechanism will allow for “breaking news” in any category to be added to the profile automatically. This solves a problem of exposing the user to subjects that could have high levels of interest but are rare and hence can be missing from profiles.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “module” or “system.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

What is claimed is:

1. A method for controlled introduction of noise to information filtering, comprising:
requesting information by a user having a user profile, said requesting comprising one of a direct request by the user, and an indirect request based on the information filtering for the user;
obtaining the requested information;
generating the noise related to the requested information and the user profile; and
presenting the requested information and the noise in an information stream.

2. The method of claim 1, wherein the step of generating comprises:
finding aggregate profiles relevant to the user profile;
obtaining the noise from non-overlapping parts of the aggregate profiles; and
prioritizing the noise based on predefined rules.

3. The method of claim 2, wherein each of the aggregate profiles comprises at least one characteristic found in the user profile.

4. The method of claim 2, wherein the aggregate profiles are constructed using one of data mining, and data aggregation mechanisms.

5. The method of claim 1, wherein the noise is generated using one of random selection, and complex selection algorithms.

6. The method of claim 1, wherein the step of presenting includes at least one of printing, transmitting electronically, and displaying.

7. A computer readable storage medium storing a program of instructions executable by a machine to perform a method of controlled introduction of noise to information filtering, comprising:
requesting information by a user having a user profile, said requesting comprising one of a direct request by the user, and an indirect request based on the information filtering for the user;
obtaining the requested information;
generating the noise related to the requested information and the user profile; and
presenting the requested information and the noise in an information stream.

8. The computer readable storage medium of claim 7, wherein the step of generating comprises:
finding aggregate profiles relevant to the user profile;
obtaining the noise from non-overlapping parts of the aggregate profiles; and
prioritizing the noise based on predefined rules.

9. The computer readable storage medium of claim 8, wherein each of the aggregate profiles comprises at least one characteristic found in the user profile.

10. The computer readable storage medium of claim 8, wherein the aggregate profiles are constructed using one of data mining, and data aggregation mechanisms.

11. The computer readable storage medium of claim 7, wherein the noise is generated using one of random selection, and complex selection algorithms.

12. The computer readable storage medium of claim 7, wherein the step of presenting includes at least one of printing, transmitting electronically, and displaying.

13. A system for controlled introduction of noise to information filtering, comprising:
an information filter obtaining information in response to a direct request by a user having a user profile or an indirect request based on the information filtering for the user;
a noise generator generating the noise related to the obtained information and the user profile; and
an information presenter presenting the obtained information and the noise in an infoimation stream.

14. The system of claim 13, further comprising information profiles, wherein the noise generator finds aggregate profiles of the information profiles relevant to the user profile, said noise generator obtains the noise from non-overlapping parts of the aggregate profiles and prioritizes the noise based on predefined rules.

15. The system of claim 14, wherein each of the aggregate profiles comprises at least one characteristic found in the user profile.

16. The system of claim 14, wherein the aggregate profiles are constructed using one of data mining, and data aggregation mechanisms.

17. The system of claim 13, wherein the noise generator generate the noise using one of random selection, and complex selection algorithms.

18. The system of claim 13, wherein the information presenter performs presenting using at least one of printing, transmitting electronically, and displaying.
